(19) United States
(12) Patent Application Publication
(10) Pub. No.: US 2026/0116563 A1
(43) Pub. Date: Apr. 30, 2026

(54) PHASE SYNCHRONIZATION OF VEHICLE ENGINES TO REDUCE NOISE AND VIBRATION

(71) Applicant: Gulfstream Aerospace Corporation, Savannah, GA (US)

(72) Inventors: Kristopher Lynch, Savannah, GA (US); Nicholas Ward, Savannah, GA (US); Thomas Snyder, Savannah, GA (US)

(73) Assignee: Gulfstream Aerospace Corporation, Savannah, GA (US)

(21) Appl. No.: 18/928,396

(22) Filed: Oct. 28, 2024

(51) Int. Cl. B64D 31/12

(52) U.S. Cl. CPC B64D 31/12

(57) ABSTRACT

A method of electronically controlling operation of a vehicle is disclosed here. The vehicle has two engines, and the disclosed method involves: obtaining respective tachometer data from the two engines; obtaining vibration data from vibration sensors associated with the two engines; calculating a vibration phase angle between the two engines, the vibration phase angle calculated from the tachometer data from the engines and from the vibration data for the engines; and controlling operation of one or both of the engines, in response to the calculated vibration phase angle.

### TECHNICAL FIELD

Embodiments of the subject matter described herein relate generally to vehicle control systems and their related sensors and instrumentation. More particularly, embodiments of the subject matter relate to aircraft engine control systems that regulate the speed and synchronization of aircraft engines to reduce unwanted noise and vibration caused by rotational imbalance of one or more of the engines.

### BACKGROUND

A vehicle, such as an aircraft, may have one or more engines or motors that rotate at a speed that is regulated by an operator or electronic controller of the vehicle. Ideally, each engine is rotationally balanced in a way that minimizes vibrations and noise that would otherwise be caused by rotational imbalance. In most realistic multi-engine applications, however, at least one engine can exhibit some rotational imbalance that results in perceptible vibration and/or detectable noise, both of which are undesirable.

Accordingly, it is desirable to address unwanted noise and vibration caused by rotational imbalance of engines onboard a vehicle. Furthermore, other desirable features and characteristics will become apparent from the subsequent detailed description and the appended claims, taken in conjunction with the accompanying drawings and the foregoing technical field and background.

### BRIEF SUMMARY

The subject matter presented here relates to a system and related methodology that can be implemented onboard a vehicle to reduce vibration and noise caused by the rotation of two cooperating engines. In accordance with certain disclosed embodiments, the methodology utilizes vibration sensors installed on aircraft engines, along with engine tachometers, to calculate a vibration phase angle between the two engines. This vibration phase information can be provided to an avionics computer or engine control system, which generates and applies an appropriate throttle trim command or load to initiate a small adjustment to at least one of the engines. The adjustment is intended to make the vibration phases between the two engines opposite (out of phase), resulting in cancellation of at least some of the vibration on the aircraft, and reduction of noise and vibration. The onboard computer-based system will continuously monitor and trim the control of the engine(s) to maintain an anti-phase relationship between the vibration phases of the engines.

In certain embodiments, the system can be implemented with an onboard engine vibration health monitor unit (EVHMU) to provide processed data via an aircraft communication bus. Alternatively, the system may be implemented using a separate computer module, device, or system that receives and processes signals provided by the engine tachometers and vibration sensors, e.g., from from a maintenance connector of the EVHMU. In other implementations, the system can include or be realized with an electronic engine computer onboard the host vehicle.

In accordance with certain embodiments, a method of electronically controlling operation of a vehicle is disclosed. The vehicle has a first engine and a second engine that cooperate to provide propulsion for the vehicle. The disclosed method involves: obtaining first tachometer data from a first tachometer associated with the first engine; obtaining second tachometer data from a second tachometer associated with the second engine; obtaining first vibration data from a first vibration sensor associated with the first engine; obtaining second vibration data from a second vibration sensor associated with the second engine; calculating a vibration phase angle between the first engine and the second engine, the vibration phase angle calculated from the first tachometer data, the second tachometer data, the first vibration data, and the second vibration data; and controlling operation of the first engine and/or the second engine, in response to the calculated vibration phase angle.

Also disclosed is a system onboard a vehicle having a first engine and a second engine that cooperate to provide propulsion for the vehicle. Certain embodiments of the system include: at least one processor; and at least one processor-readable medium associated with the at least one processor, the at least one processor-readable medium storing processor-executable instructions configurable to be executed by the at least one processor to perform a method of controlling operation of the vehicle. The disclosed method involves: obtaining first tachometer data from a first tachometer associated with the first engine; obtaining second tachometer data from a second tachometer associated with the second engine; obtaining first vibration data from a first vibration sensor associated with the first engine; obtaining second vibration data from a second vibration sensor associated with the second engine; calculating a vibration phase angle between the first engine and the second engine, the vibration phase angle calculated from the first tachometer data, the second tachometer data, the first vibration data, and the second vibration data; and controlling operation of the first engine and/or the second engine, in response to the calculated vibration phase angle.

Also disclosed is a vehicle having: a first engine; a second engine; a first tachometer associated with the first engine; a second tachometer associated with the second engine; a first vibration sensor associated with the first engine; a second vibration sensor associated with the second engine; a computer-based system having at least one processor; and at least one processor-readable medium associated with the at least one processor. The at least one processor-readable medium stores processor-executable instructions configurable to be executed by the at least one processor to perform a method of controlling operation of the vehicle. Certain embodiments of the disclosed method involve: obtaining first tachometer data from the first tachometer; obtaining second tachometer data from the second tachometer; obtaining first vibration data from the first vibration sensor; obtaining second vibration data from the second vibration sensor; calculating a vibration phase angle between the first engine and the second engine, the vibration phase angle calculated from the first tachometer data, the second tachometer data, the first vibration data, and the second vibration data; and controlling operation of the first engine and/or the second engine, in response to the calculated vibration phase angle.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic top view representation of an aircraft that is configured in accordance with exemplary embodiments of the invention;

FIG. 2 is a diagram that graphically illustrates a relatively high amount of vibration or noise caused by in-phase vehicle engine imbalances;

FIG. 3 is a diagram that graphically illustrates a relatively low amount of vibration or noise caused by anti-phase vehicle engine imbalances;

FIG. 4 is a block diagram that depicts various systems and components onboard an aircraft that is configured in accordance with exemplary embodiments of the invention;

FIG. 5 is a block diagram of an exemplary embodiment of a computer-based device; and

FIG. 6 is a flow chart that illustrates an exemplary embodiment of an engine control process that can be implemented to electronically control the operation of a vehicle, such as an aircraft.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software, or the like, various elements of the systems and devices described herein are essentially the code segments or instructions that cause one or more processor devices to perform the various tasks. In certain embodiments, the program or code segments are stored in at least one tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like.

A control system and related control methodologies are disclosed herein. The disclosed subject matter can be utilized to electronically control the operation of a vehicle (such as aircraft) having at least two engines with rotational components. In accordance with certain non-limiting embodiments, the disclosed system and related control processes are deployed onboard an airplane. However, it should be appreciated that embodiments of the disclosed subject matter can be utilized for other vehicle applications including, without limitation: helicopters; automobiles; watercraft; submarines; transportation systems; spacecraft; or the like. For the sake of brevity, conventional techniques related to signal processing, sensor data collection and transmission, engine speed control, engine synchronization control, and other functional aspects of the systems (and the individual operating components of the systems) may not be described in detail herein.

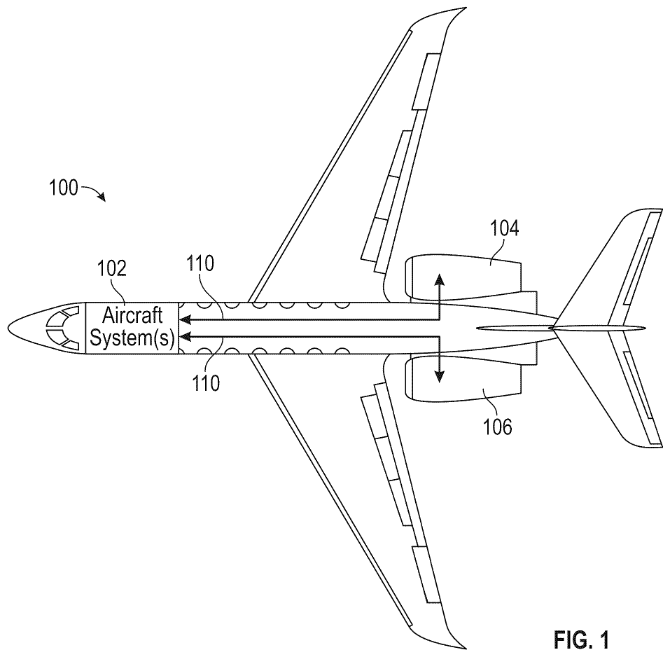

Turning now to the drawings, FIG. 1 is a schematic top view representation of an aircraft 100 having one or more onboard aircraft systems 102, which may include, without limitation, any of the following in combination and in any number of iterations or multiples: a computer-based or processor-based flight control (avionics) system; a computer-based or processor-based health monitoring system; engine health monitoring sensors (e.g., accelerometers, tachometers, vibration sensors). FIG. 1 represents the various onboard aircraft systems 102 as a single block, but it should be understood that an embodiment of the aircraft 100 will implement the onboard aircraft systems 102 with a variety of different physical, logical, and computer-implemented components.

At least one of the onboard aircraft systems 102 is associated with a first engine 104 of the aircraft 100, and at least one of the onboard aircraft systems 102 is associated with a second engine 106 of the aircraft 100. The engines 104, 106 cooperate to provide propulsion for the aircraft 100 in a regulated and controlled manner. In this regard, the onboard aircraft systems 102 may be communicatively coupled to the engines 104, 106 (and/or to components, sensors, devices, or electronic modules that are utilized with the engines 104, 106) to receive data related to the operating state, condition, or status of the engines 104, 106. Moreover, the onboard aircraft systems 102 may be communicatively coupled to the engines 104, 106 (and/or to components, sensors, device, or electronic modules that are utilized with the engines 104, 106) to provide signals, commands, data, or instructions that control the operation of the engines 104, 106.

For example, the onboard aircraft systems 102 can issue throttle control signals to adjust rotational speed of the engines 104, 106. As another example, the onboard aircraft systems 102 can issue control signals to adjust the speed synchronization or the phase synchronization of the engines 104, 106. As yet another example, the onboard aircraft systems 102 can issue control signals to adjust accessory loading on the engines 104, 106. As a further example, the onboard aircraft systems 102 can issue control signals to adjust one or more engine performance parameters or metrics of the engines 104, 106. These and other engine control schemes and methodologies may be supported by one or more of the onboard aircraft systems 102. To this end, FIG. 1 schematically illustrates two communication paths 110 leading from the onboard aircraft systems 102 to the engines 104, 106. These communication paths 110 represent physical and/or wireless data communication channels that are suitably configured, maintained, and operated to carry sensor signals and control signals between the engines 104, 106 and the applicable onboard aircraft systems 102. For simplicity and ease of illustration, FIG. 1 depicts one communication path 110 associated with the engine 104, and one communication path 110 associated with the engine 106. Although only two communication paths 110 are shown in FIG. 1, the aircraft 100 may support any number of communication paths 110 as needed to support the features and functionality described herein, and to provide any required redundancy.

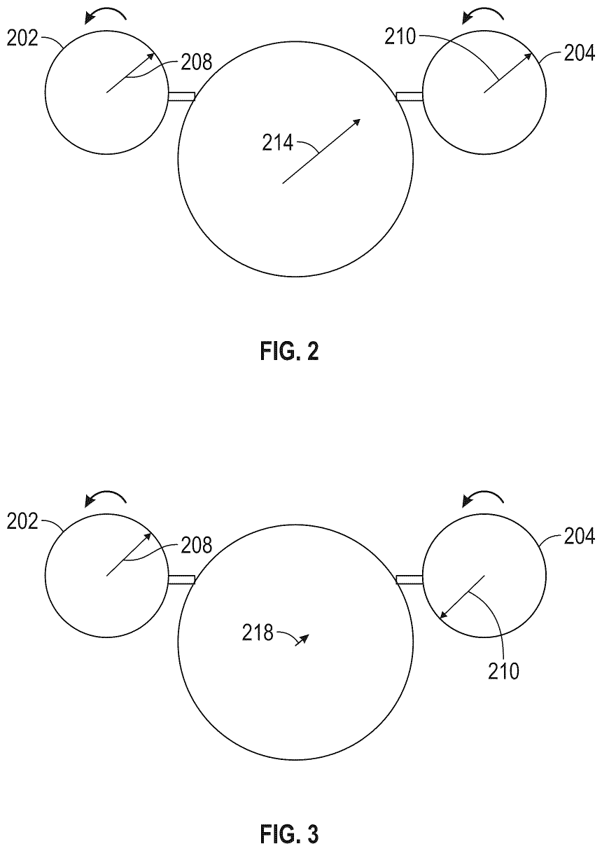

FIG. 2 is a diagram that graphically illustrates a relatively high amount of vibration (or noise) caused by in-phase vehicle engine imbalances. A first engine 202 and a second engine 204 are operated such that they rotate at the same rotational speed (ideally) and in the same direction (arbitrarily depicted as counterclockwise in FIG. 2). Ideally, both engines 202, 204 are rotationally balanced and spin without generating any unwanted noise or vibration. In practice, however, an amount of rotational imbalance is usually present. Accordingly, FIG. 2 graphically depicts the rotational imbalance of the first engine 202 as a first vector 208, and graphically depicts the rotational imbalance of the second engine 204 as a second vector 210. Each vector 208, 210 indicates the magnitude of the imbalance (vibration) and the position of the imbalance relative to a fixed reference point, such as top dead center of the respective engine 202, 204. FIG. 2 illustrates a condition where the rotational imbalances are in phase with one another—the two vectors 208, 210 are pointing in the same or substantially the same direction. As a result of this in-phase condition, occupants of the host vehicle will experience a “combined” amount of vibration or noise, which is graphically depicted as a vibration vector 214. The vibration vector 214 has a relatively high magnitude and a direction that is in phase with the two individual vectors 208, 210.

In contrast to the scenario shown in FIG. 2, FIG. 3 graphically illustrates a relatively low amount of vibration (or noise) caused by anti-phase vehicle engine imbalances. The phase angle of the vector 208 is the same in both FIG. 2 and FIG. 3, which graphically represents the same rotational imbalance of the first engine 202. The phase angle of the vector 210, however, is different in FIG. 3. More specifically, the phase angle of the vector 210 shown in FIG. 3 is 180 degrees out of phase with the vector 210 shown in FIG. 2. Consequently, the vectors 208, 210 are out of phase under the conditions depicted in FIG. 3. As a result of this anti-phase condition, occupants of the host vehicle will experience a reduced amount of “combined” vibration or noise, which is graphically depicted as a much shorter vibration vector 218. The vibration vector 218 has a relatively low magnitude and a direction that indicates the overall combined vibration phase angle. The system and control scheme disclosed here are designed to reduce the amount of vibration/noise caused by the engine imbalances, by controlling the operation of at least one of the engines such that the rotational imbalances are anti-phase relative to each other.

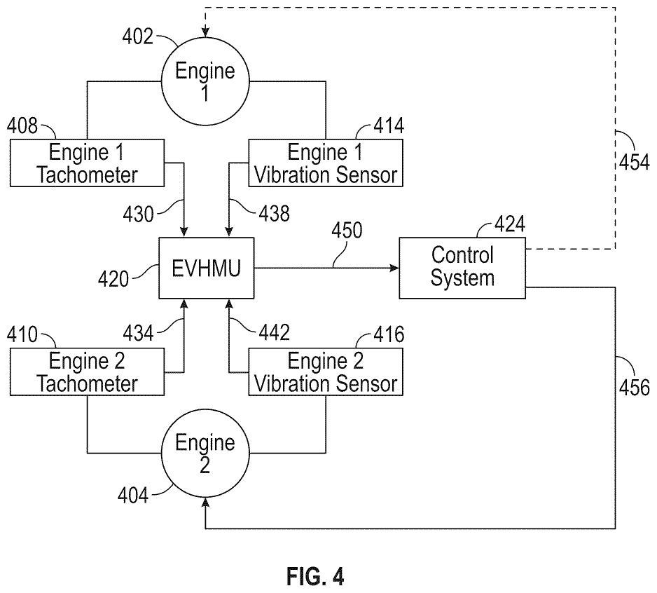

FIG. 4 is a block diagram that depicts various systems and components that may be onboard the aircraft 100. Indeed, the onboard aircraft systems 102 shown in FIG. 1 may include some or all of the systems and components depicted in FIG. 4. The exemplary embodiment depicted in FIG. 4 can be implemented as a system that electronically controls operation of a host vehicle. More specifically, the system is suitably configured and designed to control the operation of at least one engine 402, 404 of an aircraft. The embodiment shown in FIG. 4 includes the following features, devices, subsystems, components, or the like: at least one tachometer 408 associated with the engine 402; at least one tachometer 410 associated with the engine 404; at least one vibration sensor 414 associated with the engine 402; at least one vibration sensor 416 associated with the engine 404; and a computer-based system that may include any number of computer devices, controllers, control units, processors, logic elements, or the like. The depicted implementation of the onboard computer-based system includes, without limitation, at least one engine vibration health monitoring unit (EVHMU) 420 and at least one flight control, avionics, and/or electronic engine control (EEC) system 424. A deployed implementation of the aircraft 100 may include some or all of these systems and components, additional systems and components (as needed or desired), and/or alternative systems and components (as needed or desired). FIG. 4 is merely an illustrative example that depicts certain systems and components that support the inventive subject matter described herein. For example, although FIG. 4 depicts the EVHMU 420 and the control system 424 as separate blocks, an embodiment of the deployed system may integrate the functionality of the EVHMU 420 and the control system 424 and implement such functionality using any number of physical hardware components, computer devices, or electronic modules as appropriate for the particular deployment.

Although not depicted separately in FIG. 4, the aircraft 100 includes or cooperates with at least one data communication network that facilitates communication between the various components, systems, and logic onboard the aircraft 100. For example, the data communication network can be utilized to communicate sensor data, measurements, alerts, messages, flight control commands, and the like. In this regard, the data communication network can be utilized to: communicate engine-related information (such as tachometer data and vibration sensor data) to the EVHMU 420; communicate data between the EVHMU 420 and the control system 424; communicate commands or control signals between the control system 424 and the engines 402, 404; and the like.

The tachometer 408 for the first engine 402 may be integrated with the first engine 402 or it can be realized as a distinct component or instrument that is coupled to or otherwise communicates with the first engine 402. The tachometer 408 is configured to provide its tachometer data 430 to the EVHMU 420, wherein the tachometer data 430 indicates a rotational speed of the first engine 402. In accordance with embodiments where the first engine 402 is a turbofan engine, the tachometer data 430 indicates rotational speed of a drive shaft of the first engine 402. In this regard, the tachometer data 430 may include data that indicates the rotational speed of a high pressure compressor drive shaft of the first engine 402 and/or data that indicates the rotational speed of a low pressure compressor drive shaft of the first engine 402. The rotational speed is typically expressed in terms of revolutions per unit of time, such as revolutions per minute (RPM). In certain embodiments, the tachometer data 430 also indicates position of the rotating element (e.g., drive shaft) of the first engine 402 relative to a stationary reference point of the first engine 402. The stationary reference point may be, for example, the top dead center position (twelve o'clock) of the first engine 402 or any chosen position relative to a 360 degree coordinate system.

Similarly, the tachometer 410 for the second engine 404 may be integrated with the second engine 404 or it can be realized as a distinct component or instrument that is coupled to or otherwise communicates with the second engine 404. The tachometer 410 is configured to provide its tachometer data 434 to the EVHMU 420, wherein the tachometer data 434 indicates a rotational speed of the second engine 404. In accordance with embodiments where the second engine 404 is a turbofan engine, the tachometer data 434 indicates rotational speed of at least one drive shaft of the second engine 402. In this regard, the tachometer data 434 may include data that indicates the rotational speed of a high pressure compressor drive shaft of the second engine 404 and/or data that indicates the rotational speed of a low pressure compressor drive shaft of the second engine 404. In certain embodiments, the tachometer data 434 also indicates position of the rotating element (e.g., drive shaft) of the second engine 404 relative to a stationary reference point of the second engine 404. The stationary reference point may be, for example, the top dead center position (twelve o'clock) of the second engine 404 or any chosen position relative to a 360 degree coordinate system.

The vibration sensor 414 for the first engine 402 may be integrated with the first engine 402 or it can be realized as a distinct component or instrument that is coupled to or otherwise communicates with the first engine 402. In certain embodiments, the vibration sensor 414 includes or is realized as an accelerometer. The vibration sensor 414 is configured to provide its vibration data 438 to the EVHMU 420. The vibration data 438 may include or indicate, without limitation: frequency information related to rotational imbalance of the first engine 402; amplitude or magnitude information related to rotational imbalance of the first engine 402; and phase information related to rotational imbalance of the first engine 402. In accordance with embodiments where the first engine 402 is a turbofan engine, the vibration data 438 may indicate rotational imbalance of one or more rotating components of the first engine. In this regard, the vibration data 438 may include data associated with rotational imbalance of a high pressure compressor of the first engine 402 and/or data associated with rotational imbalance of a low pressure compressor of the first engine 402.

Similarly, the vibration sensor 416 for the second engine 404 may be integrated with the second engine 404 or it can be realized as a distinct component or instrument that is coupled to or otherwise communicates with the second engine 404. In certain embodiments, the vibration sensor 416 includes or is realized as an accelerometer. The vibration sensor 416 is configured to provide its vibration data 442 to the EVHMU 420. The vibration data 442 may include or indicate, without limitation: frequency information related to rotational imbalance of the second engine 404; amplitude or magnitude information related to rotational imbalance of the second engine 404; and phase information related to rotational imbalance of the second engine 404. In accordance with embodiments where the second engine 404 is a turbofan engine, the vibration data 442 may indicate rotational imbalance of one or more rotating components of the second engine. In this regard, the vibration data 442 may include data associated with rotational imbalance of a high pressure compressor of the second engine 404 and/or data associated with rotational imbalance of a low pressure compressor of the second engine 404.

In accordance with the illustrated embodiment, the EVHMU 420 obtains and processes information that is associated with operational status of the engines 402, 404, including, without limitation: the tachometer data 430 from the tachometer 408; the vibration data 438 from the vibration sensor 414; the tachometer data 434 from the tachometer 410; and the vibration data 442 from the vibration sensor 416. The EVHMU 420 outputs or otherwise provides information or data 450 to the control system 424. The provided data 450 may include, without limitation: any or all of the data obtained from the engines 402, 404 or components associated with the engines 402, 404; data, control signals, commands, or instructions that are calculated from or otherwise based on data received at the EVHMU 420; or a combination thereof.

In certain embodiments, the data 450 includes or identifies the vibration phase associated with imbalance of the first engine 402, and the vibration phase associated with imbalance of the second engine 404. Referring again to FIG. 2 and FIG. 3, the vibration phase corresponds to the angle defined by the vibration vectors, relative to a reference position, a reference angle, or the like. In certain embodiments, the data 450 also includes or identifies an engine position phase that indicates position of the first engine 402 relative to the second engine 404, or vice versa.

The control system 424 obtains and processes at least some of the data 450 provided by the EVHMU 420. In accordance with certain embodiments, a new parameter (the Engine 1 versus Engine 2 position) is generated by the EVHMU 420, and the new parameter gets applied to the ARINC data, which the control system 424 reads to calculate the relative vibration phase angle.

In accordance with the exemplary embodiment presented here, the control system 424 calculates the vibration phase angle between the first engine 402 and the second engine 404. The calculated vibration phase angle is utilized to regulate or otherwise control the operation of the first engine 402 and/or the second engine 404 to reduce noise and vibration that is caused by the imbalance of the two engines 402, 404. More specifically, the flight control (avionics) system responds to the calculated vibration phase angle by generating and issuing appropriate control signals or commands 454 for the first engine 402 and/or appropriate control signals or commands 456 for the second engine 404. In practice, noise and vibration reduction can be effectively achieved by controlling the operation of only one of the two engines 402, 404. Accordingly, FIG. 4 depicts the path for the commands 454 in dashed lines to indicate that these commands 454 are optional for the illustrated embodiment.

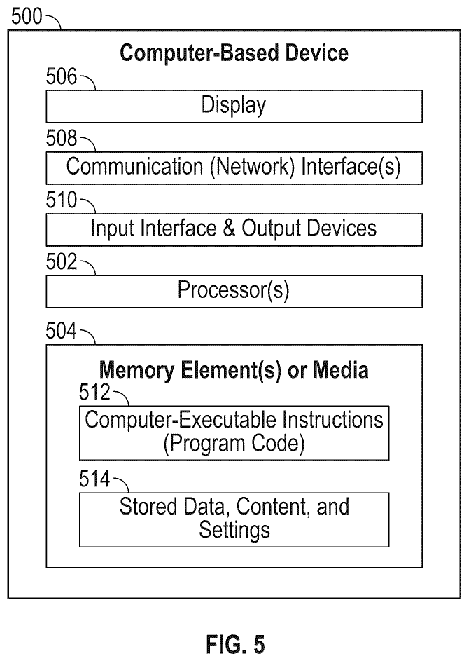

In accordance with certain embodiments, the aircraft system(s) 102 depicted in FIG. 1, and one or more of the items depicted in FIG. 4, can be implemented as at least one computer-based or a processor-based device, system, or piece of equipment. In this regard, FIG. 5 is a simplified block diagram representation of an exemplary embodiment of a computer-based device 400, which may be used to implement certain devices or systems onboard the aircraft 100.

The device 500 generally includes, without limitation: at least one processor 502; at least one memory storage device, storage media, or memory element 504; a display 506; at least one communication (network) interface 508; and input and output (I/O) devices 510, such as an input interface, one or more output devices, one or more human/machine interface elements, or the like. In practice, the device 500 can include additional components, elements, and functionality that may be conventional in nature or unrelated to the particular application and methodologies described here.

A processor 502 may be, for example, a central processing unit (CPU), a field programmable gate array (FPGA), a microcontroller, an application specific integrated circuit (ASIC), or any other logic device or combination thereof. One or more memory elements 504 are communicatively coupled to the at least one processor 502, and can be implemented with any combination of volatile and non-volatile memory. The memory element 504 has non-transitory processor-readable and processor-executable instructions (program code) 512 stored thereon, wherein the instructions 512 are configurable to be executed by the at least one processor 502 as needed. When executed by the at least one processor 502, the instructions 512 cause the at least one processor 502 to perform the associated tasks, processes, and operations defined by the instructions 512. Of course, the memory element 504 may also include instructions associated with a file system of the host device 500 and instructions associated with other applications or programs. Moreover, the memory element 504 can serve as a data storage unit for the host device 500. For example, the memory element 504 can provide storage 514 for aircraft data, navigation data, sensor data, measurements, image and/or video content, settings or configuration data for the aircraft, and the like.

The display 506 (if deployed with the particular embodiment of the device 500) may be integrated with the device 500 or communicatively coupled to the device 500 as a peripheral or accessory component. The shape, size, resolution, and technology of the display 506 will be appropriate to the particular implementation of the device 500. The display 506 can be realized as a monitor, touchscreen, or another conventional electronic display that is capable of graphically presenting data and/or information provided by the device 500.

The communication interface 508 represents the hardware, software, and processing logic that enables the device 500 to support data communication with other devices. In practice, the communication interface 508 can be suitably configured to support wireless and/or wired data communication protocols as appropriate to the particular embodiment. For example, the communication interface 508 can be designed to support a cellular communication protocol, a short-range wireless protocol (such as the BLUETOOTH communication protocol), and/or a WLAN protocol. As another example, if the device 500 is a computer, then the communication interface can be designed to support the BLUETOOTH communication protocol, a WLAN protocol, and a LAN communication protocol (e.g., Ethernet). In accordance with certain aircraft applications, the communication interface 508 is designed and configured to support one or more onboard network protocols used for the communication of information between devices, components, and subsystems of the aircraft 100.

The I/O devices 510 enable a user of the device 500 to interact with the device 500 as needed. In practice, the I/O devices 510 may include, without limitation: an input interface to receive data for handling by the device 500; a speaker, an audio transducer, or other audio feedback component; a haptic feedback device; a microphone; a mouse or other pointing device; a touchscreen or touchpad device; a keyboard; a joystick; a biometric sensor or reader (such as a fingerprint reader, a retina or iris scanner, a palm print or palm vein reader, etc.); a camera; a lidar sensor; or any conventional peripheral device. In this context, a touchscreen display 506 can be categorized as an I/O device 510. Moreover, a touchscreen display 506 may incorporate or be controlled to function as a fingerprint or palm print scanner. A haptic feedback device can be controlled to generate a variable amount of tactile or physical feedback, such as vibrations, a force, knock, or bump sensation, a detectable movement, or the like. Haptic feedback devices and related control schemes are well known and, therefore, will not be described in detail here.

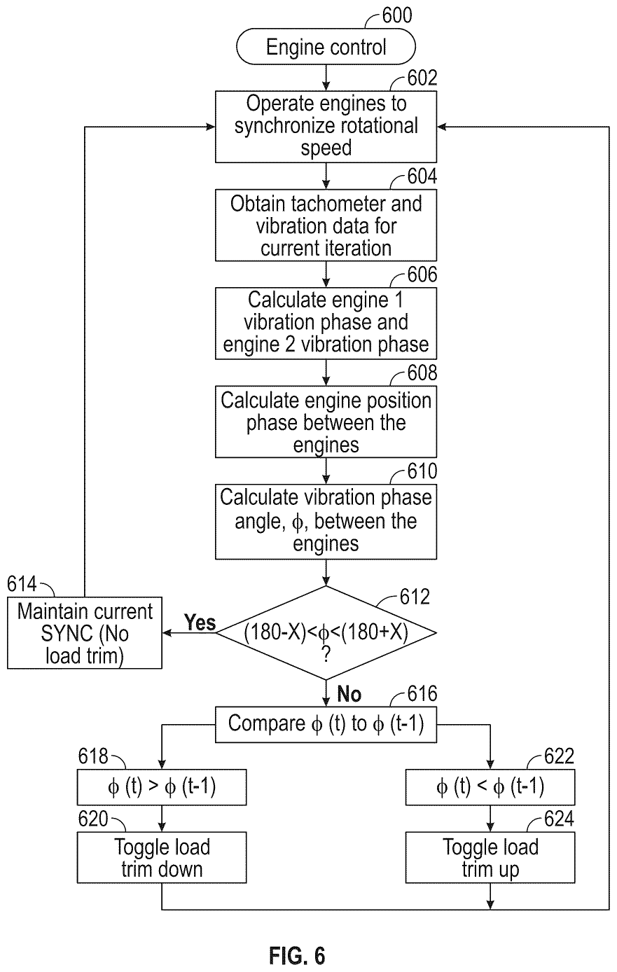

The subject matter presented here relates to a method of electronically controlling the operation of a vehicle, such as the aircraft 100, wherein the vehicle has at least two engines with rotating elements that may exhibit rotational imbalance. The control methodology adjusts certain operating parameters and/or load conditions of at least one of the engines, with the goal of reducing the noise and vibration that is caused by the rotational imbalance of the engines. In this regard, FIG. 6 is a flow chart that illustrates an exemplary embodiment of an engine control process 600 that can be implemented to electronically control the operation of a vehicle, such as an aircraft. The various tasks performed in connection with the process 600 may be performed by software, hardware, firmware, or any combination thereof. For illustrative purposes, the following description of the process 600 may refer to elements mentioned above in connection with FIGS. 1-5. In practice, portions of the process 600 may be performed by different elements of the described system, e.g., the EVHMU 420 or the control system 424. It should be appreciated that the process 600 may include any number of additional or alternative tasks, the tasks shown in FIG. 6 need not be performed in the illustrated order, and the process 600 may be incorporated into a more comprehensive procedure or process having additional functionality not described in detail herein. Moreover, one or more of the tasks shown in FIG. 6 could be omitted from an embodiment of the process 600 as long as the intended overall functionality remains intact.

The described implementation of the process 600 assumes that at least two engines are operated and controlled to synchronize their rotational speed (task 602). In other words, the engines under consideration are monitored and controlled as needed to maintain the same angular velocity, within the practical tolerances called for by the particular deployment. For the current iteration of the process 300, at least the following information is obtained for the given sampling time or time period: first tachometer data from a first tachometer associated with a first engine; second tachometer data from a second tachometer associated with a second engine; first vibration data from a first vibration sensor associated with the first engine; and second vibration data from a second vibration sensor associated with the second engine (task 604). The process 300 continues by calculating or otherwise obtaining: a first vibration phase associated with imbalance of the first engine; and a second vibration phase associated with imbalance of the second engine (task 606). If applicable, the calculation performed at task 606 utilizes the first vibration data to obtain the first vibration phase, and utilizes the second vibration data to obtain the second vibration phase.

The process 300 also calculates or otherwise obtains an engine position phase that indicates position of the first engine relative to the second engine (task 608). If applicable, the calculation performed at task 608 utilizes the first tachometer data and the second tachometer data to obtain the engine position phase between the two engines. For the exemplary embodiment described here, the engine position phase is used to calculate a vibration phase angle between the first engine and the second engine, or vice versa (task 610). More specifically, the vibration phase angle is calculated from the first vibration phase, the second vibration phase, and the engine position phase. Thus, the vibration phase angle is calculated based on the first tachometer data, the second tachometer data, the first vibration data, and the second vibration data. In certain embodiments, the vibration phase angle is calculated exclusively from the first tachometer data, the second tachometer data, the first vibration data, and the second vibration data. In other words, the vibration phase angle can be determined by leveraging information provided by the tachometers and the vibration sensors, and without relying on any special instrumentation, additional sensors, or external monitoring equipment.

For example, the vibration phase angle can be mathematically calculated and minimized (ideally to zero) by controlling to a minimum angle around 180 degrees. In this regard, the following expression is applicable:

$$E 2\_ Vib \_ phase - E 1 \_ Vib \_ phase + E 12 \_ tach \_ phase = 180$$

In this expression, E1_Vib_phase is the vibration phase angle of the first engine, E2_Vib_phase is the vibration phase angle of the second engine, and E12_tach_phase is the engine position phase between the first and second engines, as derived from the tachometer data.

The determined vibration phase angle indicates the extent by which the engine imbalances are in phase or out of phase. The methodology disclosed here utilizes the obtained vibration phase angle to control the operation of at least one of the engines in an appropriate manner to reduce the noise and vibration caused by the engine imbalances. To this end, the process 300 may continue by controlling the operation of the first engine and/or the second engine, in response to the calculated vibration phase angle. In accordance with certain embodiments, the process 300 controls the operation of the engine(s) by regulating load trim of the first engine and/or the second engine in a suitable manner to adjust the vibration phase angle toward 180 degrees. In other words, the process 300 makes appropriate adjustments in association with at least one engine, with the goal of driving the vibration phases of the engines out of phase. To this end, the process 300 may check whether the calculated vibration phase angle falls within a specified range that includes 180 degrees. FIG. 6 includes a query task 612 that checks whether (180−x)<φ< (180+x), where x represents a desired threshold value that defines the range.

If the current value of the vibration phase angle falls within the defined range (the “Yes” branch of query task 612), then the engines are controlled to maintain the current speed and phase synchronization (task 614). In other words, the process 300 makes no load trim adjustment, and returns to task 602 for the next processing iteration. If the current value of the vibration phase angle falls outside of the defined range (the “No” branch of query task 612), then the process 300 continues by comparing the current value of the vibration phase angle to the previous value of the vibration phase angle (task 616). If the current value is greater than the previous value (as indicated by block 618), then the process 300 continues by toggling load trim down for at least one engine (task 620). In contrast, if the current value is less than than the previous value (as indicated by block 622), then the process 300 continues by toggling load trim up for at least one engine (task 624). After adjusting the load trim at task 620 or task 624, the process 300 returns to task 602 for the next processing iteration.

Toggling the load trim up or down for an engine results in a quick adjustment “pulse” or “burst” or “blip” applied to the engine, which in turn alters the relative position between the two engines, and thus the relative vibration phase angle between the engines. Regulating load trim of an aircraft engine can be achieved in various ways. In accordance with one non-limiting example, the act of regulating load trim can be achieved by adjusting rotational speed of a first engine to alter the vibration phase associated with imbalance of the first engine, and/or by adjusting rotational speed of a second engine to alter the vibration phase associated with imbalance of the second engine. A brief and temporary adjustment of engine speed results in a corresponding shift in the relative position of the engines, and thus the relative vibration phase angle between the two engines. The process 300 can regulate the amount and direction of the angular shift in an attempt to achieve an anti-phase state.

In accordance with another non-limiting example, the act of regulating load trim can be achieved by adjusting accessory loading of a first engine to alter the vibration phase associated with imbalance of the first engine, and/or by adjusting accessory loading of a second engine to alter the vibration phase associated with imbalance of the second engine. Engine loading affects vibration phase by causing the loaded engine to speed up or slow down slightly, which changes the relative position of the engines, and thus changes the relative vibration phase between the engines. Loading could be things like electrical load from the integrated drive generator of the aircraft, hydraulic loading, or other actuation from an accessory load.

In accordance with yet another non-limiting example, the act of regulating load trim can be achieved by adjusting an engine performance parameter or metric of a first engine to alter the vibration phase associated with imbalance of the first engine, and/or by adjusting an engine performance parameter or metric of a second engine to alter the vibration phase associated with imbalance of the second engine. The adjusted engine performance parameter or metric can be any of the following, without limitation: a change in the efficiency of the engine turbine by adjusting compressor or turbine variable guide vanes. Any of these would be temporary loads that would be applied as a toggle or duty cycle until the feedback loop indicates the desired relative phase.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of electronically controlling operation of a vehicle having a first engine and a second engine that cooperate to provide propulsion for the vehicle, the method comprising:
obtaining first tachometer data from a first tachometer associated with the first engine;
obtaining second tachometer data from a second tachometer associated with the second engine;
obtaining first vibration data from a first vibration sensor associated with the first engine;
obtaining second vibration data from a second vibration sensor associated with the second engine;
calculating a vibration phase angle between the first engine and the second engine, the vibration phase angle calculated from the first tachometer data, the second tachometer data, the first vibration data, and the second vibration data; and
controlling operation of the first engine and/or the second engine, in response to the calculated vibration phase angle.

2. The method of claim 1, wherein the vibration phase angle is calculated exclusively from the first tachometer data, the second tachometer data, the first vibration data, and the second vibration data.

3. The method of claim 1, wherein:
the first tachometer data indicates rotational speed of a drive shaft of the first engine, and indicates position of the drive shaft of the first engine relative to a first stationary reference point of the first engine;
the second tachometer data indicates rotational speed of a drive shaft of the second engine, and indicates position of the drive shaft of the second engine relative to a second stationary reference point of the second engine.

4. The method of claim 1, wherein the step of calculating the vibration phase angle comprises:
calculating a first vibration phase associated with imbalance of the first engine;
calculating a second vibration phase associated with imbalance of the second engine; and
calculating an engine position phase that indicates position of the first engine relative to the second engine;
wherein the vibration phase angle is calculated from the first vibration phase, the second vibration phase, and the engine position phase.

5. The method of claim 1, wherein the step of controlling operation of the first engine and/or the second engine comprises:
regulating load trim of the first engine and/or the second engine to adjust the vibration phase angle toward 180 degrees.

6. The method of claim 5, wherein the step of regulating load trim comprises:
adjusting rotational speed of the first engine to alter a first vibration phase associated with imbalance of the first engine, and/or adjusting rotational speed of the second engine to alter a second vibration phase associated with imbalance of the second engine.

7. The method of claim 5, wherein the step of regulating load trim comprises:
adjusting accessory loading of the first engine to alter a first vibration phase associated with imbalance of the first engine, and/or adjusting accessory loading of the second engine to alter a second vibration phase associated with imbalance of the second engine.

8. The method of claim 5, wherein the step of regulating load trim comprises:
adjusting an engine performance parameter or metric of the first engine to alter a first vibration phase associated with imbalance of the first engine, and/or adjusting an engine performance parameter or metric of the second engine to alter a second vibration phase associated with imbalance of the second engine.

9. A system onboard a vehicle having a first engine and a second engine that cooperate to provide propulsion for the vehicle, the system comprising:
at least one processor; and
at least one processor-readable medium associated with the at least one processor, the at least one processor-readable medium storing processor-executable instructions configurable to be executed by the at least one processor to perform a method of controlling operation of the vehicle, the method comprising:
obtaining first tachometer data from a first tachometer associated with the first engine;
obtaining second tachometer data from a second tachometer associated with the second engine;
obtaining first vibration data from a first vibration sensor associated with the first engine;
obtaining second vibration data from a second vibration sensor associated with the second engine;
calculating a vibration phase angle between the first engine and the second engine, the vibration phase angle calculated from the first tachometer data, the second tachometer data, the first vibration data, and the second vibration data; and
controlling operation of the first engine and/or the second engine, in response to the calculated vibration phase angle.

10. The system of claim 9, wherein the vibration phase angle is calculated exclusively from the first tachometer data, the second tachometer data, the first vibration data, and the second vibration data.

11. The system of claim 9, wherein the step of calculating the vibration phase angle comprises:
calculating a first vibration phase associated with imbalance of the first engine;
calculating a second vibration phase associated with imbalance of the second engine; and
calculating an engine position phase that indicates position of the first engine relative to the second engine;
wherein the vibration phase angle is calculated from the first vibration phase, the second vibration phase, and the engine position phase.

12. The system of claim 9, wherein the step of controlling operation of the first engine and/or the second engine comprises:
regulating load trim of the first engine and/or the second engine to adjust the vibration phase angle toward 180 degrees.

13. The system of claim 12, wherein the step of regulating load trim comprises:
adjusting rotational speed of the first engine to alter a first vibration phase associated with imbalance of the first engine, and/or adjusting rotational speed of the second engine to alter a second vibration phase associated with imbalance of the second engine.

14. The system of claim 12, wherein the step of regulating load trim comprises:
adjusting accessory loading of the first engine to alter a first vibration phase associated with imbalance of the first engine, and/or adjusting accessory loading of the second engine to alter a second vibration phase associated with imbalance of the second engine.

15. The system of claim 12, wherein the step of regulating load trim comprises:
adjusting an engine performance parameter or metric of the first engine to alter a first vibration phase associated with imbalance of the first engine, and/or adjusting an engine performance parameter or metric of the second engine to alter a second vibration phase associated with imbalance of the second engine.

16. The system of claim 9, wherein:
the first vibration sensor comprises a first accelerometer; and
the second vibration sensor comprises a second accelerometer.

17. A vehicle comprising:
a first engine;
a second engine;
a first tachometer associated with the first engine;
a second tachometer associated with the second engine;
a first vibration sensor associated with the first engine;
a second vibration sensor associated with the second engine;
a computer-based system having at least one processor; and
at least one processor-readable medium associated with the at least one processor, the at least one processor-readable medium storing processor-executable instructions configurable to be executed by the at least one processor to perform a method of controlling operation of the vehicle, the method comprising:
obtaining first tachometer data from the first tachometer;
obtaining second tachometer data from the second tachometer;
obtaining first vibration data from the first vibration sensor;
obtaining second vibration data from the second vibration sensor;
calculating a vibration phase angle between the first engine and the second engine, the vibration phase angle calculated from the first tachometer data, the second tachometer data, the first vibration data, and the second vibration data; and
controlling operation of the first engine and/or the second engine, in response to the calculated vibration phase angle.

18. The vehicle of claim 17, wherein the step of calculating the vibration phase angle comprises:
calculating a first vibration phase associated with imbalance of the first engine;
calculating a second vibration phase associated with imbalance of the second engine; and
calculating an engine position phase that indicates position of the first engine relative to the second engine;
wherein the vibration phase angle is calculated from the first vibration phase, the second vibration phase, and the engine position phase.

19. The vehicle of claim 17, wherein the step of controlling operation of the first engine and/or the second engine comprises:
regulating load trim of the first engine and/or the second engine to adjust the vibration phase angle toward 180 degrees.

20. The vehicle of claim 17, wherein:
the first vibration sensor comprises a first accelerometer; and
the second vibration sensor comprises a second accelerometer.
